(19) United States
(12) Patent Application Publication
(10) Pub. No.: US 2010/0229884 A1
(43) Pub. Date: Sep. 16, 2010

(54) System For Cleaning And Massaging A Foot

(76) Inventor: Nir Alony, Eilat (IL)

Correspondence Address: The Law Office of Michael E. Kondoudis, 888 16th Street, N.W., Suite 800, Washington, DC, 20006, US

(21) Appl. No.: 12/401,671

(22) Filed: Mar. 11, 2009

(51) Int. Cl. A45D 29/00; A47K 7/02; A43B 17/00; A61H 1/00

(52) U.S. Cl. 132/73.5; 132/76.4; 15/160; 15/210.1; 15/227; 2/239; 601/22

(57) ABSTRACT

A system for treating a foot. One system comprises an external container comprising tracks; and an inner appliance comprising foot treating elements. In operation, the foot is placed within the inner appliance and in contact with the foot treating elements, which are associated with the tracks such that moving the foot within the inner appliance back and forth in the external container activates the foot treating elements to apply a foot treatment. In embodiments, the foot treating elements comprise wheels operatively associated with the tracks, brushes, massaging elements, manicure elements and so forth. One system further comprises a double layered pellets' sock arranged to enhance massaging. One system further comprises a lotion sock comprising inbound pores connected to ducts connected to lotion bags with therapeutic lotion, excreted by motion of the foot treating elements.

### BACKGROUND

1. Technical Field

The present invention relates to the field of body treatment, and more particularly, to a foot treatment apparatus.

2. Discussion of Related Art

Treatment of the foot is an important part of life quality and an important factor of sustaining good health.

U.S. Patent Publication No. US2008201879, which discloses a foot cleaning device, is incorporated herein by reference in its entirety

The following patents and patent applications are incorporated herein by reference in their entirety: Chinese Patent Document No. CN201097673, which discloses a footbath massage boot; Slovenian Patent Document No. SI0021220C, which discloses a massage shoe sock; Chinese Patent Document No. CN1615764, which discloses a massage health shoe; Japanese Patent Document No. JP02077253, which discloses a massage device; Canadian Patent Document No. CA2347380, which discloses a sock that enhances circulation in the lower legs and feet; and European Patent Document No. EP0423852, which discloses a plantar hydro-massage device.

The following patents and patent applications are incorporated herein by reference in their entirety: U.S. Pat. No. 5,682,690, which discloses a footwear with adjustable massage units; Ukrainian Patent Document No. UA0013069U, which discloses a footwear for periodical massage during a day; Japanese Patent Document No. JP11113606, which discloses a ball holding structure for stimulating the foot; and Spanish Patent Document No. ES2029634, which discloses a footwear for stimulating blood circulation.

The following patents and patent applications are incorporated herein by reference in their entirety: U.S. Pat. No. 6,792,701, which discloses a footwear product for therapeutically treating the skin; and U.S. Patent Publication No. US2004199093, which discloses a therapeutic shoe.

### BRIEF SUMMARY

Embodiments of the present invention provide a system for treating a foot. One system comprises an external container comprising a plurality of tracks; and an inner appliance comprising a plurality of foot treating elements. In operation, the foot is placed within the inner appliance and in contact with the plurality of foot treating elements, and the plurality of foot treating elements is associated with the plurality of tracks such that moving the foot within the inner appliance back and forth in the external container activates the plurality of foot treating elements to apply a foot treatment.

Accordingly, according to an aspect of the present invention, there is provided a system, wherein the plurality of foot treating elements comprises a plurality of wheels operatively associated with the plurality of tracks, wherein operably, the external container is arranged to allow moving the plurality of wheels along the tracks by moving the foot within the inner appliance back and forth.

Accordingly, according to another aspect of the present invention, there is provided a system, wherein the plurality of foot treating elements comprises a plurality of brushes, wherein the external container further comprises at least one drainage canal, and wherein operably, the external container is arranged to allow moving the plurality of brushes by moving the foot within the inner appliance back and forth.

Accordingly, according to another aspect of the present invention, there is provided a system, wherein the plurality of foot treating elements comprises a plurality of massaging elements arranged to apply a massage treatment to the foot within the inner appliance.

Accordingly, according to yet another aspect of the present invention, there is provided a system, further comprising a double layered pellets' sock comprising movable pellets that are constricted by two layers of the pellets' sock. The pellets' sock is made of soft and elastic materials, and operably, moving the foot moves the plurality of pellets such as to massage the foot. In embodiments, the plurality of moving elements are arranged to utilize the motion of the plurality of wheels upon moving the foot within the external container—to move the plurality of pellets such as to massage the foot.

Accordingly, according to still another aspect of the present invention, there is provided a system, further comprising a lotion sock comprising: a plurality of inbound pores connected to at least one duct; and at least one lotion bag comprising a therapeutic lotion. The lotion sock is made of a thin nonabsorbent material, and in operation, moving the foot applies pressure upon the at least one lotion bag causing excretion of the therapeutic lotion onto the foot and circulation of the therapeutic lotion through the at least one duct. In embodiments, the plurality of moving elements are arranged to utilize the motion of the plurality of wheels upon moving the foot within the external container—to apply pressure upon the at least one lotion bag and thereby excrete the therapeutic lotion onto the foot and circulate the therapeutic lotion through the at least one duct.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a high level schematic diagram of an external container, according to some embodiments of the invention;

FIG. 2 is a schematic perspective view of an inner appliance according to some embodiments of the invention;

FIG. 3 is a schematic cross section of an inner appliance according to some embodiments of the invention;

FIGS. 4 and 5 are a schematic top views of an inner appliance according to some and varying embodiments of the invention; and

FIG. 6 is a schematic perspective view of an inner appliance comprising a lotion sock, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

A system for cleaning and massaging a foot comprising an external container 100 and an inner appliance 120 is presented in the following figures.

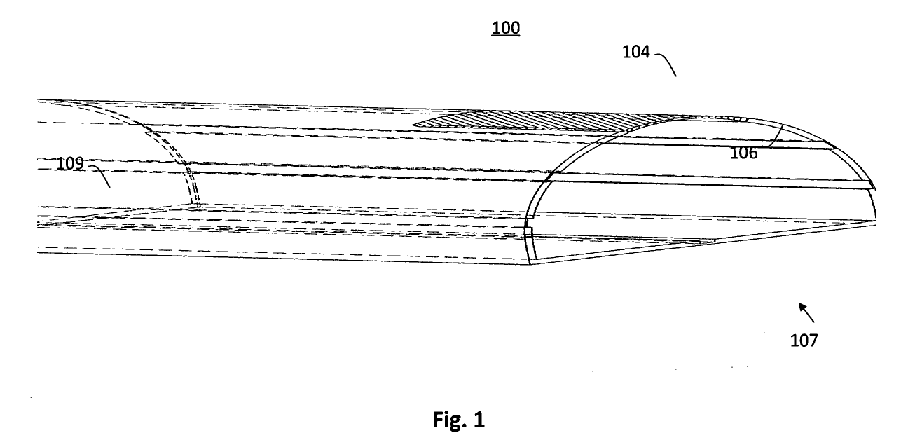

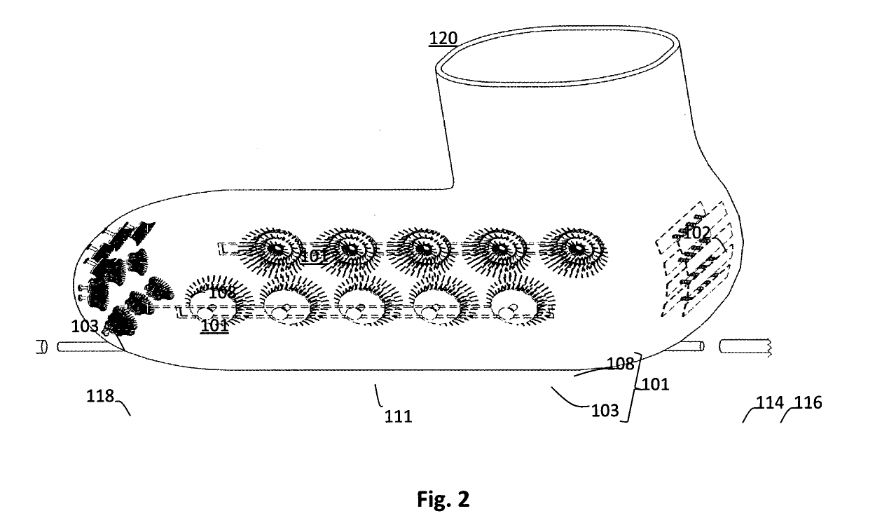

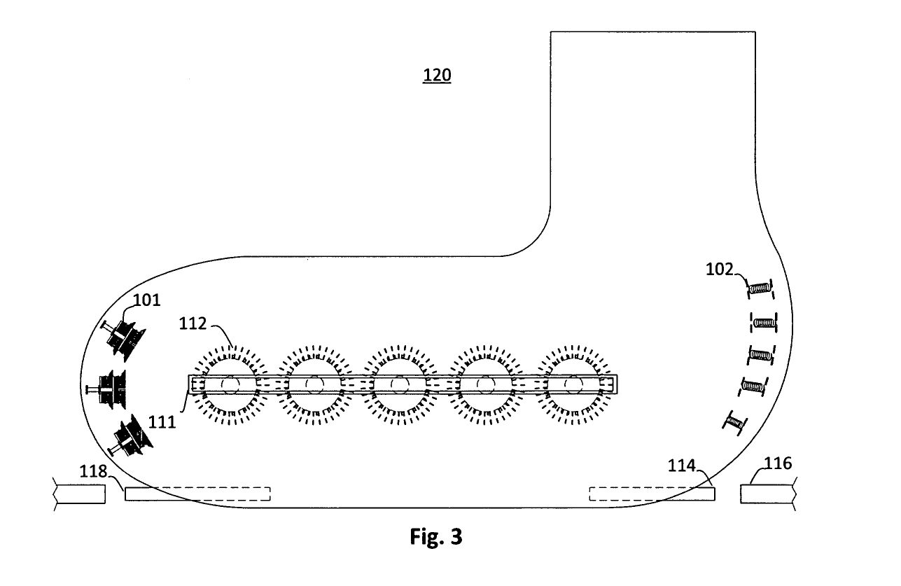

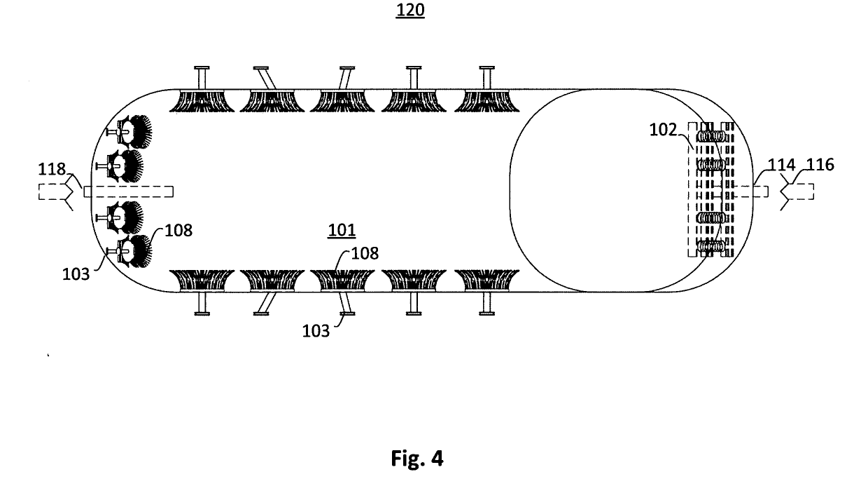

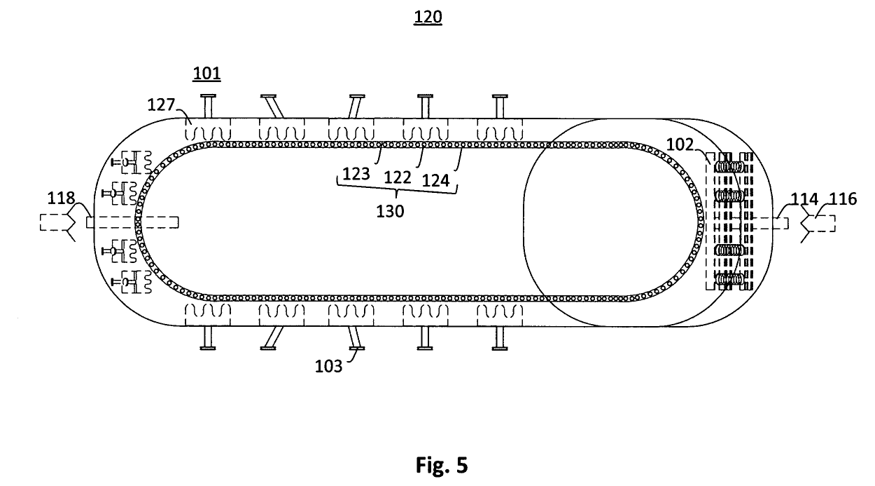

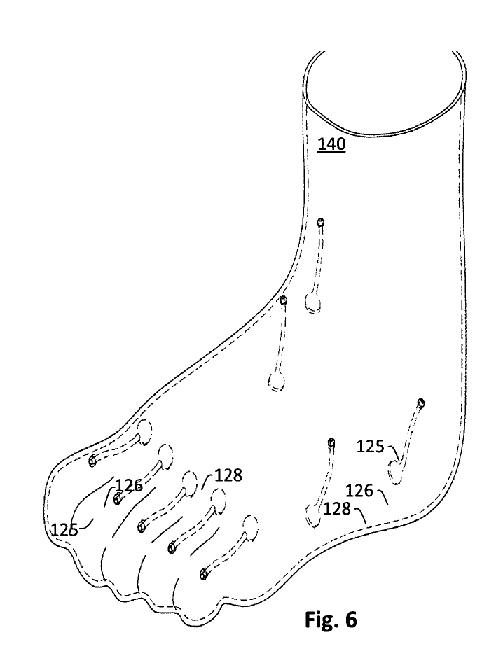

FIG. 1 is a high level schematic diagram of external container 100, according to some embodiments of the invention. FIGS. 2, 3, 4, 5 and 6 are high level schematic diagrams of inner appliance 120, according to some and varying embodiments of the invention. FIG. 2 is a schematic perspective view of inner appliance 120 according to some embodiments of the invention. FIG. 3 is a schematic cross section of inner appliance 120 according to some embodiments of the invention. FIGS. 4 and 5 are a schematic top section views of inner appliance 120 according to some and varying embodiments of the invention. FIG. 6 is a schematic perspective view of inner appliance 120 comprising a lotion sock, according to some embodiments of the invention.

External container 100 (FIG. 1) allows placing a foot within inner appliance 120 into external container 100. External container 100 further allows connect activation mechanisms of inner appliance 120 a tracks 106 on the inner sides of external container 100. External container 100 may further comprise one or more drainage canals 109. Water and soap placed in external container 100 may circulate the foot, enhance the cleansing process and drain via drainage canal 109. External container 100 may be arranged to allow massaging a foot within inner appliance 120 by moving the foot and the resulting movement of foot treating elements 101. In operation, external container 100 may be arranged to allow moving wheels 103 along tracks 106, and to allow moving brushes 108, by moving the foot within inner appliance 120 back and forth.

External container 100 may comprise a flexible adjustment area 104 arranged to allow placing the foot within external container 100 and eventually fastening the foot to external container 100. Adjustment area 104 may be adapted to receive wither foot or foot within inner appliance 120.

Inner appliance 120 (FIGS. 2 and 4) comprises foot treating elements 101 such as wheels 103 and brushes 108, that may be connected to tracks 106 as well. Foot treating elements 101 may be interconnected by supporting elements 111. External container 100 may be arranged to allow cleaning a foot placed in it by moving the foot and the resulting movement of foot treating elements 101 connected to inner appliance 120 such as wheels 103 and brushes 108.

According to some embodiments of the invention, inner appliance 120 may further comprise an adjustable element 102, arranged to allow fitting inner appliance 120 to the foot.

According to some embodiments of the invention, inner appliance 120 may further comprise a connector 114 connected to inner appliance 120 and to a mechanical controller 116 external to external container 100. External container 100 may comprise openings 107 for allowing connector 114 or mechanical controller 116 go through external container 100. Connector 114 may be arranged to move foot treating elements 101 (for example, wheels 103 or brushes 108) and/or the foot itself. Connector 114 may allow externally activating external container 100 by mechanical controller 116 and thereby enhancing the cleaning and massaging of the foot. Mechanical controller 116 may be activated by either the user, a physician or a helper for cases the user cannot move the foot inside external container 100 or needs help in moving the foot.

According to some embodiments of the invention, inner appliance 120 may further comprise connectors 118, arranged to transmit movement outside of external container 100, for example to nail files connected to connector 118, and arranged to allow filing nails of a foot outside external container 100 utilizing the movement transmitted by connectors 118. In this manner both feet may be treated simultaneously utilizing movements of one foot. External container 100 may comprise openings 107 for allowing connector 114 or mechanical controller 116 go through external container 100. According to some embodiments of the invention, external container 100 may further comprise an external fluid container (not shown), arranged to allow treating a foot outside external container 100.

The system may further comprise manicure elements 112 attached to brushes 108 or to wheels 103 (as in FIG. 3), and arranged to remove skin from the foot. The location and movement modes of manicure elements 112 may be configured to fit a specific foot.

According to some embodiments of the invention, external container 100 may be arranged to allow moving foot treating elements 101 by moving the foot according to predefined movement patterns. Movement patterns may comprise lifting and pressing heels, toes, or other parts of the foot, sideways, or any other movement pattern. Certain movements of the foot may mechanically control operation modes of external container 100.

According to some embodiments of the invention, foot treating elements 101 may comprise wheels 103 and moving elements 127 (FIG. 5). Wheels 103 are operatively associated with tracks 106, wherein operably, external container 100 is arranged to allow moving wheels 103 along tracks 106 by moving the foot within inner appliance 120 back and forth. Moving elements 127 may be connected to wheels 103 and arranged to receive motion from wheels 103.

According to some embodiments of the invention, the system may further comprise a double layered pellets' sock 130 (FIG. 5) comprising movable pellets 122 that are constricted by two layers of the pellets' sock 123, 124. Pellets' sock 130 may be made of soft and elastic materials. In operation, moving the foot moves pellets 122 such as to massage and clean the foot.

According to some embodiments of the invention, pellets' sock 130 may be activated by moving elements 127. Both pellets' sock 130 and moving elements 127 may be arranged to operate together to massage the foot. Different operation modes may be applicable to the combined motion—such as various forms of moving elements 127, various motion patterns of moving elements 127, and various arrangements of pellets 122. In operation, moving elements 127, are arranged to utilize the motion of wheels 103 upon moving the foot within external container 100- to move pellets 122 such as to massage the foot.

According to some embodiments of the invention, the system may further comprise a lotion sock 140 (FIG. 6) that may comprise inbound pores 125 connected to at least one duct 126, and at least one lotion bag 128 comprising a therapeutic lotion. Lotion sock 140 may be made of a thin nonabsorbent material. In operation, moving the foot applies pressure upon lotion bags 128 causing excretion of the therapeutic lotion onto the foot and circulation of the therapeutic lotion through the ducts 126.

According to some embodiments of the invention, lotion sock 140 may be activated by moving elements 127. Both lotion sock 140 and moving elements 127 may be arranged to operate together to massage the foot. In operation, moving elements 127 are arranged to utilize the motion of wheels 103 upon moving the foot within external container 100—to apply pressure upon lotion bags 128 and thereby excrete the therapeutic lotion onto the foot and circulate the therapeutic lotion through ducts 126.

According to some embodiments of the invention, the systems operate mechanically, avoiding use of electricity. It provides a full treatment of the foot in a time efficient manner and a user friendly platform.

According to some embodiments of the invention, any of external container 100, inner appliance 120, pellets' sock 130, or lotion sock 140 may be arranged to sustain either heat or coldness, e.g.′ sustain a predefined temperature, or in general to regulate the temperature of the foot.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A system for treating a foot comprising:
an external container comprising a plurality of tracks; and
an inner appliance comprising a plurality of foot treating elements,
wherein operably, the foot is placed within the inner appliance and in contact with the plurality of foot treating elements, and
wherein operably, the plurality of foot treating elements is associated with the plurality of tracks such that moving the foot within the inner appliance back and forth in the external container activates the plurality of foot treating elements to apply a foot treatment.

2. The system of claim 1, wherein the plurality of foot treating elements comprises a plurality of wheels operatively associated with the plurality of tracks, wherein operably, the external container is arranged to allow moving the plurality of wheels along the tracks by moving the foot within the inner appliance back and forth.

3. The system of claim 1, wherein the plurality of foot treating elements comprises a plurality of brushes, wherein the external container further comprises at least one drainage canal, and wherein operably, the external container is arranged to allow moving the plurality of brushes by moving the foot within the inner appliance back and forth.

4. The system of claim 3, further comprising water and degenerate, and wherein operably, moving the foot within the external container allows cleansing the foot.

5. The system of claim 3, further comprising a plurality of manicure elements attached to the plurality of brushes and arranged to remove skin from the foot.

6. The system of claim 1, wherein the plurality of foot treating elements comprises a plurality of manicure elements arranged to remove skin from the foot.

7. The system of claim 1, further comprising:
a connector connected to the inner appliance; and
a mechanical controller external to the inner appliance and connected to the connector,
wherein the connector is arranged to move the plurality of foot treating elements, allowing externally activating the inner appliance by the mechanical controller and thereby enhancing the cleaning and massaging of the foot.

8. The system of claim 1, wherein operably, the external container is arranged to allow moving the plurality of foot treating elements by moving the foot within the inner appliance back and forth according to at least one predefined movement pattern.

9. The system of claim 1, further comprising at least one connector, arranged to transmit movement outside of the external container.

10. The system of claim 9, further comprising a plurality of nail files connected to the at least one connector, and arranged to allow filing nails of a foot outside the external container utilizing the movement transmitted by the at least one connector.

11. The system of claim 1, further comprising an external fluid container, arranged to allow treating a foot outside the external container.

12. The system of claim 1, wherein the plurality of foot treating elements comprise a plurality of massaging elements arranged to apply a massage treatment to the foot within the inner appliance.

13. The system of claim 1, further comprising a double layered pellets' sock comprising movable pellets that are constricted by two layers of the pellets' sock, wherein the pellets' sock is made of soft and elastic materials, and wherein operably, moving the foot moves the plurality of pellets such as to massage the foot.

14. The system of claim 1, further comprising a lotion sock comprising:
a plurality of inbound pores connected to at least one duct; and
at least one lotion bag comprising a therapeutic lotion,
wherein the lotion sock is made of a thin nonabsorbent material, and
wherein operably, moving the foot applies pressure upon the at least one lotion bag causing excretion of the therapeutic lotion onto the foot and circulation of the therapeutic lotion through the at least one duct.

15. The system of claim 1, the plurality of foot treating elements further comprising:
a plurality of wheels operatively associated with the plurality of tracks, wherein operably, the external container is arranged to allow moving the plurality of wheels along the tracks by moving the foot within the inner appliance back and forth, and
a plurality of moving elements connected to the plurality of wheels and arranged to receive motion from the plurality of wheels.

16. The system of claim 15, further comprising a double layered pellets' sock comprising movable pellets that are constricted by two layers of the pellets' sock, wherein the pellets' sock is made of soft and elastic materials,
wherein operably, the foot is placed within the double layered pellets' sock, both are placed within the inner appliance, and all three are placed within the external container, and
wherein operably, the plurality of moving elements are arranged to utilize the motion of the plurality of wheels upon moving the foot within the external container—to move the plurality of pellets such as to massage the foot.

17. The system of claim 15, further comprising a lotion sock comprising a plurality of inbound pores connected to at least one duct; and at least one lotion bag comprising a therapeutic lotion,
wherein the lotion sock is made of a thin nonabsorbent material, and
wherein operably, the foot is placed within the lotion sock, both are placed within the inner appliance, and all three are placed within the external container, and
wherein operably, the plurality of moving elements are arranged to utilize the motion of the plurality of wheels upon moving the foot within the external container—to apply pressure upon the at least one lotion bag and thereby excrete the therapeutic lotion onto the foot and circulate the therapeutic lotion through the at least one duct.

18. The system of claim 1, wherein the external container further comprises a flexible adjustment area arranged to allow placing the foot within the inner appliance into the external container and further arranged to enable fastening the foot within the inner appliance to the external container.

19. The system of claim 1, wherein the inner appliance further comprises an adjustable element, arranged to allow fitting the inner appliance to the foot.

20. The system of claim 1, wherein at least one of: the inner appliance; and the external container, are arrange to sustain a predefined temperature.
